(19) United States
(12) Patent Application Publication
(10) Pub. No.: US 2012/0060419 A1
(43) Pub. Date: Mar. 15, 2012

(54) LOCKING CONFINEMENT DOOR MOVEMENT

(75) Inventor: Jerry W. RIGGS, Vinemont, AL (US)

(73) Assignee: WILLO PRODUCTS COMPANY, INC., Decatur, AL (US)

(21) Appl. No.: 12/939,654

(22) Filed: Nov. 4, 2010

Related U.S. Application Data
(60) Provisional application No. 61/382,573, filed on Sep. 14, 2010.

(51) Int. Cl. E05B 53/00; E05B 47/00; E05F 15/20; E05D 15/06; E05B 65/08

(52) U.S. Cl. 49/18; 49/449; 49/15; 49/29

(57) ABSTRACT

A locking prison door movement for mounting above a prison door adjacent a prison cell for transporting and locking the prison door includes a support frame and a movable carriage mounted to the support frame for reciprocating motion relative to the support frame. A drop bar extends downwardly toward the floor of the prison and is movable between a raised unlocked position and a lowered lock position in which a lower portion of the drop bar is secured adjacent the floor of the prison. An upper lock bar is movable between a first locked position securing the movable carriage in place and a second unlocked position allowing motion of the movable carriage. A cam mechanism is provided for moving the upper lock bar and the drop bar between their locked and unlocked and is operated by the reciprocating motion of the movable carriage such that the reciprocating motion of the movable carriage causes the locking and unlocking of the drop bar and the upper lock bar. The cam bar is coupled to the movable carriage in such a way that for a portion of the motion of the cam bar the cam bar and the movable carriage move together, and for some other portion of the motion of the cam bar, the cam bar continues its motion while the movable carriage remains stationary, and wherein motion of the cam bar while the movable carriage is stationary causes the locking and unlocking of the one or more locks. The upper lock bar is not visible or accessible to a prisoner, but instead is concealed within the cabinet.

### CROSS-REFERENCE TO RELATED APPLICATION

This application claims the priority benefit of U.S. Provisional Patent Application Ser. No. 61/382,573, filed Sep. 14, 2010, which is hereby incorporated herein by reference.

### TECHNICAL FIELD

The present invention relates generally to prison doors and, in particular, to a locking movement for a prison door.

### BACKGROUND

In prisons, jails, holding cells and the like, it is typical to employ a movable door that is slid back and forth in translation and to lock the door in place in the closed position, for confining one or more individuals. In many instances, such a door is further locked in place in an opened position. Typically, a door movement is mounted adjacent the door opening and includes a drop bar which drops into engagement with the floor or a latch adjacent the floor to secure the door in position.

Such a door movement can sometimes be dislodged from its locked position by rocking or other manipulation by the inmate(s). Also, in some circumstances the movement has become disabled by vandalism.

### SUMMARY

Generally described, the present invention relates to a locking movement for a confinement door in which the door is supported by a movement and operation of the movement effects both translation of the door back and forth and engagement/disengagement of one or more locks for securing the door in place.

In a first example embodiment, the invention comprises a transport and locking mechanism for mounting above a prison door adjacent a prison cell for transporting and locking the prison door. The transport and locking mechanism includes a support frame and a movable carriage mounted to the support frame for reciprocating motion relative to the support frame. A drop bar extends downwardly toward the floor of the prison and is movable between a raised unlocked position and a lowered lock position in which a lower portion of the drop bar is secured adjacent the floor of the prison. An upper lock is movable between a first locked position securing the movable carriage in place and a second unlocked position allowing motion of the movable carriage. One or more cam mechanisms are provided for moving the upper lock and the drop bar between their locked and unlocked positions. Preferably, the one or more cam mechanisms are operated by the reciprocating motion of the movable carriage such that the reciprocating motion of the movable carriage causes the locking and unlocking of the drop bar and the upper lock.

Advantageously, the provision of two locks (the upper lock and the drop bar) makes it more difficult for the inmate(s) to dislodge the movement and door from the locked position, thereby increasing security of the door. Also, the upper lock works to isolate the remainder of the movement mechanism such that attempts by the inmate(s) to dislodge or move the door do not exert forces on the remainder of the movement, thereby preserving the functionality and operational security of the transport mechanism.

Optionally, the upper lock is not visible or accessible to a prisoner, but instead is concealed within a cabinet, thereby making the movement more resistant to vandalism and damage.

In a second form, the invention comprises a transport and locking mechanism for mounting in a cabinet above a prison door adjacent a prison cell for transporting and locking the prison door. A support frame is adapted to be mounted within the cabinet and a movable carriage is mounted to the support frame for reciprocating motion relative to the support frame. A drop bar extends downwardly toward the floor of the prison and is movable between a raised unlocked position and a lowered locked position in which a lower portion of the drop bar is secured near the floor of the prison. An upper lock is movable between a first locked position securing the movable carriage to the support frame and a second unlocked position allowing relative motion between the movable carriage and the support frame. Advantageously, the upper lock is not visible or accessible to a prisoner, but instead is concealed within the cabinet.

Optionally, a cam bar is coupled to the movable carriage in such a way that for a portion of the motion of the cam bar, the cam bar and the movable carriage move together, and for some other portion of the motion of the cam bar the cam bar continues its motion while the movable carriage remains stationary. Advantageously, this allows the motion of the cam bar (while the movable carriage is stationary) to effect the locking and unlocking of the locks.

In a third form, the invention comprises a transport and locking mechanism for mounting in a cabinet above a prison door adjacent a prison cell for transporting and locking the prison door. A movable carriage mounted to a support frame for reciprocating motion relative to the support frame and for bearing the door back and forth. One or more moveable locks move between locked and unlocked positions for securing the door in place. A cam bar is mounted for reciprocating motion relative to the support frame for moving the locks between their locked and unlocked positions. The cam bar is coupled to the movable carriage in such a way that for a portion of the motion of the cam bar, the cam bar and the movable carriage move together, and for some other portion of the motion of the cam bar the cam bar continues its motion while the movable carriage remains stationary. Moreover, motion of the cam bar while the movable carriage is stationary causes the locking and unlocking of the locks.

Preferably, two movable locks are provided (an upper lock and a drop bar), making it more difficult for the inmate(s) to dislodge the movement and door from the locked position, thereby increasing security of the door. Optionally, the upper lock bar is not visible or accessible to a prisoner, but instead is concealed within a cabinet, thereby making the movement more resistant to vandalism and damage.

### BRIEF DESCRIPTION OF THE DRAWINGS

FIG. 1 is a perspective view of a prison door transport and lock mechanism according to a first example embodiment of the present invention.

FIG. 2 is a perspective view of a portion of the prison door transport and lock mechanism of FIG. 1, shown with a front cover portion thereof opened.

FIG. 3 is a perspective view of a portion of the prison door transport and lock mechanism of FIG. 1, with some elements thereof omitted for clarity of illustration.

FIG. 4 is a right side sectional view of the prison door transport and lock mechanism of FIG. 1.

FIG. 5 is a perspective view of a portion of the prison door transport and lock mechanism of FIG. 1, in particular depicting a sliding connection between a door bar portion and a cam bar portion of the prison door transport and lock mechanism.

FIG. 6A is a close-up perspective view of a portion of the prison door transport and lock mechanism of FIG. 5.

FIG. 6B is a close-up sectional view of a portion of the prison door transport and lock mechanism of FIG. 5.

FIG. 6C is a close-up perspective view of a portion of the prison door transport and lock mechanism of FIG. 5.

FIG. 7A is a close-up, partially cut-away, perspective view of a portion of the prison door transport and lock mechanism of FIG. 1.

FIG. 7B is a close-up, top perspective view of a portion of the prison door transport and lock mechanism of FIG. 7A.

FIG. 7C is a close-up, rear perspective view of a portion of the prison door transport and lock mechanism of FIG. 7A.

FIG. 8A is a schematic front elevation view of a timing mechanism portion of the prison door transport and lock mechanism of FIG. 1, showing the timing mechanism in a first condition.

FIG. 8B is a schematic front elevation view of the timing mechanism portion of the prison door transport and lock mechanism of FIG. 8A, showing the timing mechanism in a second condition.

FIG. 8C is a schematic front elevation view of the timing mechanism portion of the prison door transport and lock mechanism of FIG. 8A, showing the timing mechanism in a third condition.

FIG. 9 is a close-up perspective view of an upper deadbolt portion of the prison door transport and lock mechanism of FIG. 1.

FIG. 10 is a schematic plan view of the upper deadbolt portion of the prison door transport and lock mechanism of FIG. 9.

### DETAILED DESCRIPTION OF EXAMPLE EMBODIMENTS

Generally described, the invention relates to a confinement door support movement and lock. It provides a positive, reliable locking at the top of sliding detention doors. This locking system is concealed and tamperproof and it provides positive deadbolt locking. Forces against the door do not affect the locking mechanism, in particular the timing mechanism part of the door. The entire door operator mechanism can be driven by an electric motor through a spur gear. The spur gear can drive a linear rack gear which is welded to the cam bar. The cam bar can be attached to the wheel bar by roller bearings which allow limited independent movement of the cam bar relative to the wheel bar. The wheel bar is supported by rollers which bear on a fixed track. The door can be bolted or welded to the wheel bar. Preferably, the wheel bar and door always move together. Also preferably, the rack gear and the cam bar always move together.

When fully opened and locked, the wheel bar rests against a bumper which provides a cushion at the fully open position. The top locking pawl protrudes through a slot in the frame of the track assembly. This slot is covered by the door hanger bracket at all times. Door movement is restricted in each direction by the top locking pawl. Shaking of door can be cushioned by the bumper. Shaking of the door can be cushioned by the bumper by careful adjustment of the bumper relative to the position of the notch that receives the upper lock pawl. It is possible to have the bumper adjusted such that all shaking forces are absorbed by the upper lock.

Beginning from fully open and locked position the motor drives the cam bar through linear movement of the rack gear. In the initial movement of the cam bar, the wheel bar and door assembly remain stationary. The cam plate (which is rigidly attached to the cam bar) lifts the top locking pawl by lifting a roller which is mounted to the locking pawl. As the cam bar continues movement, it is coupled to the wheel bar by the timing mechanism. The timing lever is hinged to the wheel bar. When the cam bar makes contact with the driven pin (which protrudes from the timing lever), the wheel bar and door begin to move with the cam bar.

As door reaches fully closed position, movement of the wheel bar is stopped by the bumper. As the door approaches a fully closed position, the timing roller runs off the end of the timing cam. When the roller runs off the end of the cam, the cam bar pushes the driven pin downward, causing the lever to swivel downward. As the lever pivots the driven pin is disengaged from the cam bar allowing the cam bar to continue its movement. This movement of the cam bar causes the cam plate to lower the top locking pawl. When the cam bar reaches end of travel, the top locking pawl is locked in place by the flat surface of the cam plate which rests over the top locking pawl roller.

The unlocking and opening of the door follows the same sequence as closing the sequence. The timing of the locking and driving systems are symmetrical in either direction. In order to accommodate cells that have door openings adjacent to a common wall, opposite hand devices are built with the timing mechanisms shifted in the door open direction.

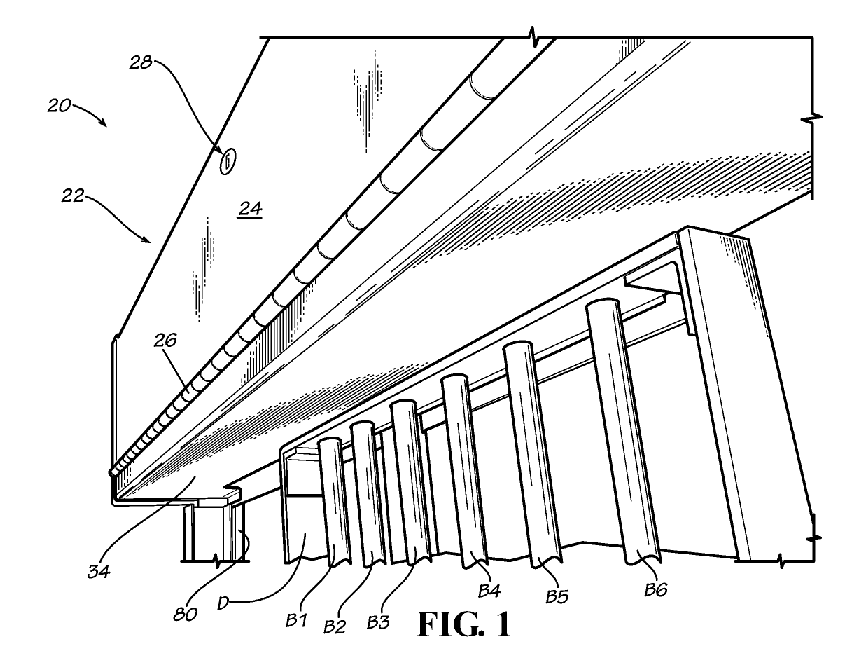

Referring now to the drawing figures, wherein like reference numerals represent like parts throughout several views, FIGS. 1-4 show a locking prison door movement 20 according to a first preferred example form of the invention. The locking prison door movement 20 is adapted for use in prisons, jails, and the like. The locking prison door movement 20 is operable to move a prison door D back and forth and for locking the prison door D in open or closed positions. The prison door or jail door D can take various shapes, such as a solid door, a solid door with a window or opening, or, as shown, series of bars, such as bars B1-B6. The locking prison door movement 20 includes a cabinet or enclosure 22 which is adapted to be mounted above the prison door D and against a wall of the prison, jail or the like. The cabinet 22 includes a front door or access door 24 which is pivotally mounted to the remainder of the cabinet 22 with a long piano hinge 26 which extends the length of the access door 24.

Advantageously, the workings of the locking prison door movement 20 are concealed within the cabinet 22 to prevent access by prisoners and to prevent the workings from being tampered with, vandalized, or otherwise interfered with. In this regard, the cabinet 22 optionally can include one or more security locks, such as security lock 28 for locking the access door 24 in its upright, locked position to prevent access to the interior of the cabinet 22. Alternatively, the access door can be held in place by cap screws, including tamper-resistant cap screws.

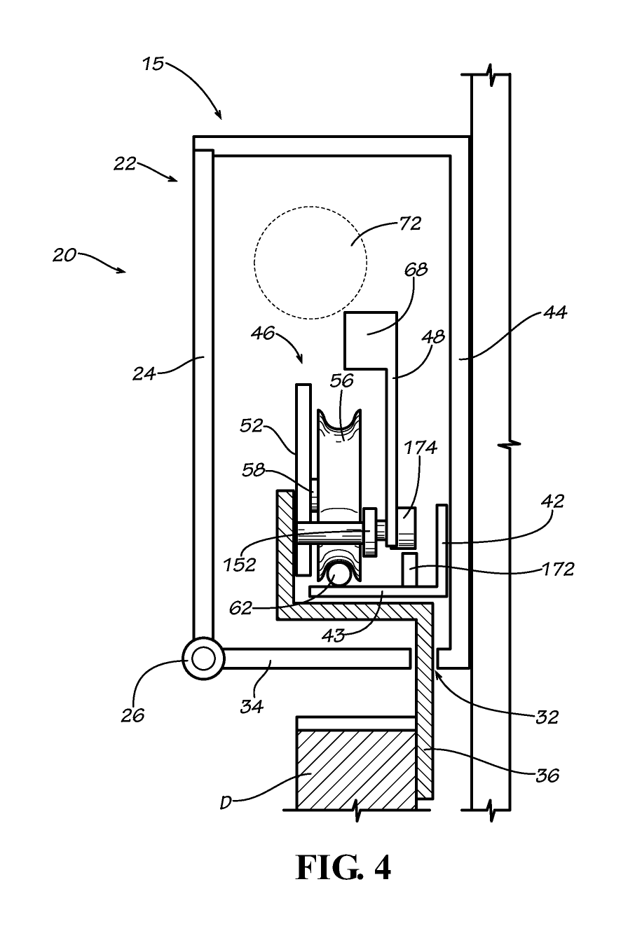

As best seen in FIG. 4, a slot or elongated opening 32 is formed in a bottom panel 34 of the cabinet 22 to allow a door hanger bracket 36 to extend downwardly through the bottom panel 34 of the cabinet 22. The door hanger bracket 36 is rigidly secured to the door, such as by welding or other mechanical fastening, and supports the door D thereupon. In this way, reciprocal motion of the door hanger bracket 36 carries the door D back and forth therealong.

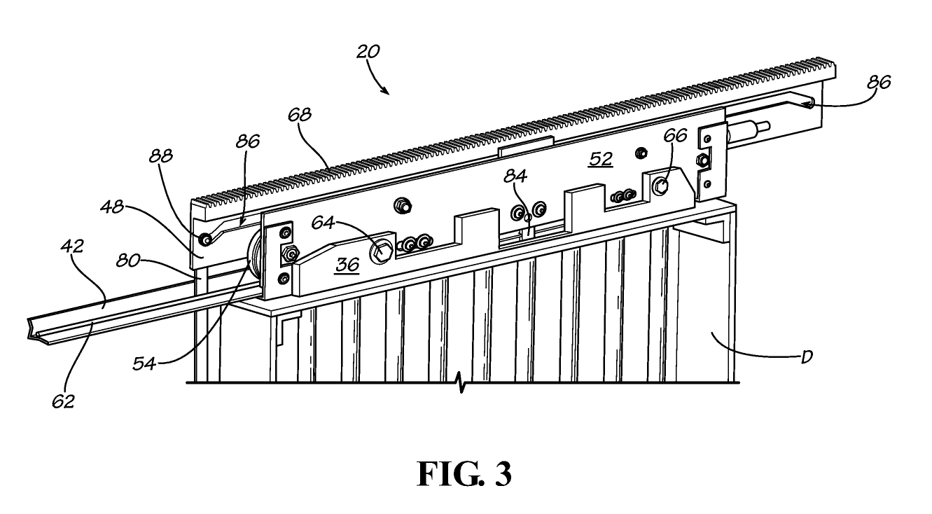

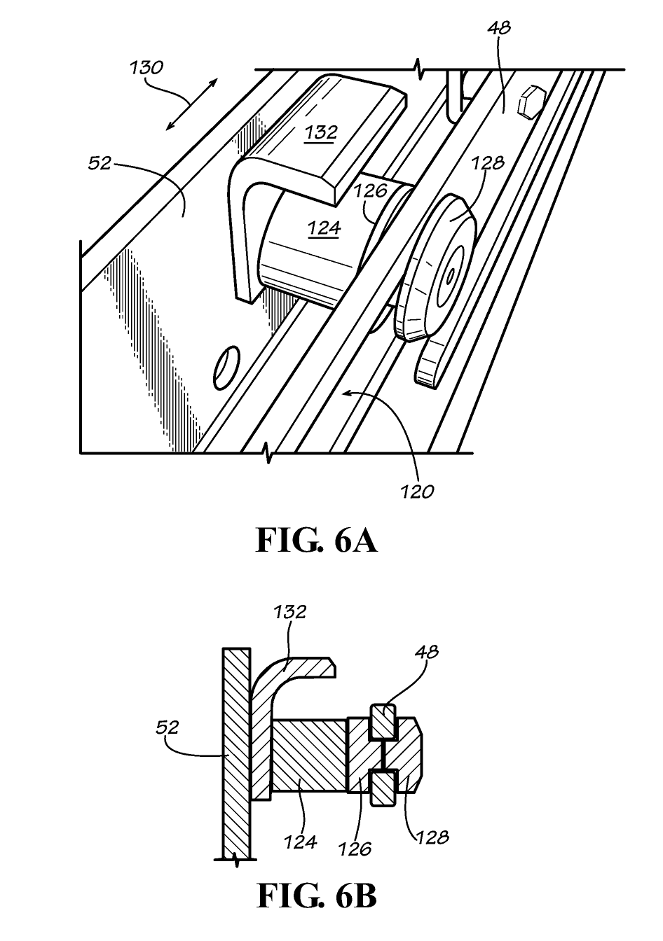

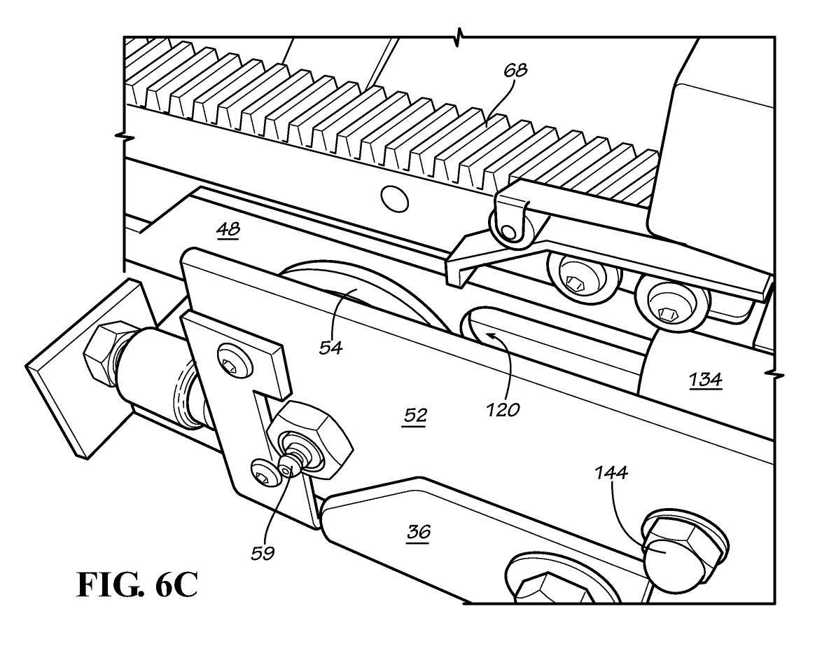

An L-shaped support frame or support brace or support bracket 42 is securely mounted to a rear panel portion 44 of the cabinet 22, as by welding, mechanical fasteners, etc. While an L-shaped support frame or support bracket 42 is shown, those skilled in the art will recognize that various shapes of such a support frame or support structure can be employed. A movable carriage 46 is mounted to the support frame 42 for reciprocating relative movement. Thus, the support frame 42 is a stationary element, while the movable carriage indicated generally at 46 reciprocates for back-and-forth movement relative to the support frame 42. The movable carriage 46 includes as primary or large components a cam bar 48 and a wheel bar 52. See also FIG. 3. Wheel bar 52 is approximately as long as the width of the door D, while the cam bar 48 is a little bit longer, for reasons that will become clearer below. Wheel bar 52 is mounted above the support frame 42 upon rotating wheels, such as wheels 54 and 56 mounted at opposite ends of the wheel bar. The wheels, such as wheel 56, are mounted for rotational movement relative to the wheel bar 52 upon greasable axles, such as axle 58. As shown in FIG. 6C, the greasable axles include a grease fitting 59 for greasing the axle to maintain smooth operation of the wheel 54. The wheels ride on a wheel track 62. The wheel track 62 comprises a length of solid steel rod welded atop the horizontal portion 43 of the support frame 42. In this way, the wheel bar 52 is guided along for reciprocating, translational movement relative to the support frame 42.

Wheel bar 52 is constructed from ¼ inch plate steel, as are many other of the components of the locking prison door movement 20. Indeed, given that the environment for the apparatus is prisons, jails, etc., it is somewhat common to construct the various components to be extra sturdy. The wheel bar 52 is in the form of a plate which is several inches high and generally is about as long as the door to be supported and moved back and forth. As best seen in FIGS. 3 and 4, the door hanger bracket 36 is bolted to the wheel bar 52 with bolts 64, 66 and is supported by the wheel bar.

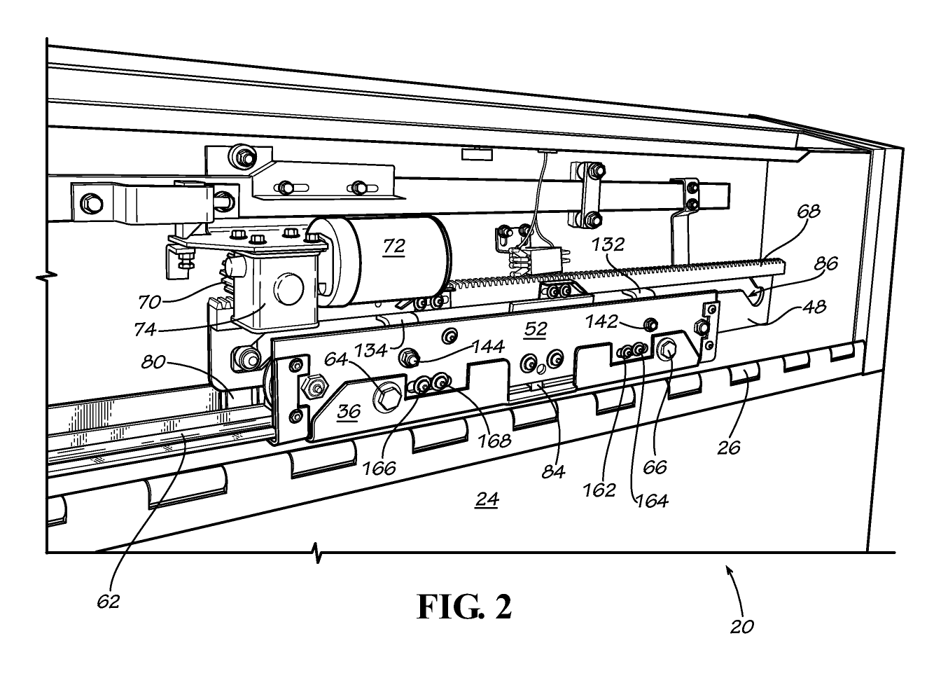

The cam bar 48 includes a gear rack 68 which is driven by a spur gear or pinion gear 70, which in turn is driven by electric motor 72 through a transmission 74. See FIG. 2.

As shown in FIGS. 1-3, a drop bar 80 extends downwardly toward the floor of the prison and is movable between a raised unlocked position and a lowered locked position in which a lower portion of the drop bar is secured adjacent the floor of the prison. In FIGS. 2 and 3, the drop bar 80 is shown in a lowered, locked position.

As shown in FIGS. 2 and 3, an upper lock bar 84 is movable between a first locked position securing the movable carriage 46 in place and a second unlocked position allowing motion of the movable carriage 46. A pair of cam mechanisms is provided for moving the upper lock bar 84 and the drop bar 80 between their locked and unlocked positions. Preferably, the cam mechanism is operated by the reciprocating motion of the movable carriage 46 such that the reciprocating motion of the movable carriage causes the locking and unlocking of the drop bar 80 and the upper lock bar 84. In this regard, the cam bar 48 includes a cam track 86 for guiding a cam roller or cam follower 88 for causing movement of the drop bar 80. The cam track 86 extends nearly the full length of the cam bar 48 and for most of the movement of the cam bar the cam follower 88 rides in an upper portion of the cam track 86 and keeps the drop bar 80 in a retracted or raised position. It is only at the extreme ends of the movement of the cam bar 48 that the cam track 86 forces the cam roller or cam follower 88 downwardly, causing the drop bar 82 to be forced lower towards the floor of the prison for engagement in the floor of the prison or in a latch adjacent thereto.

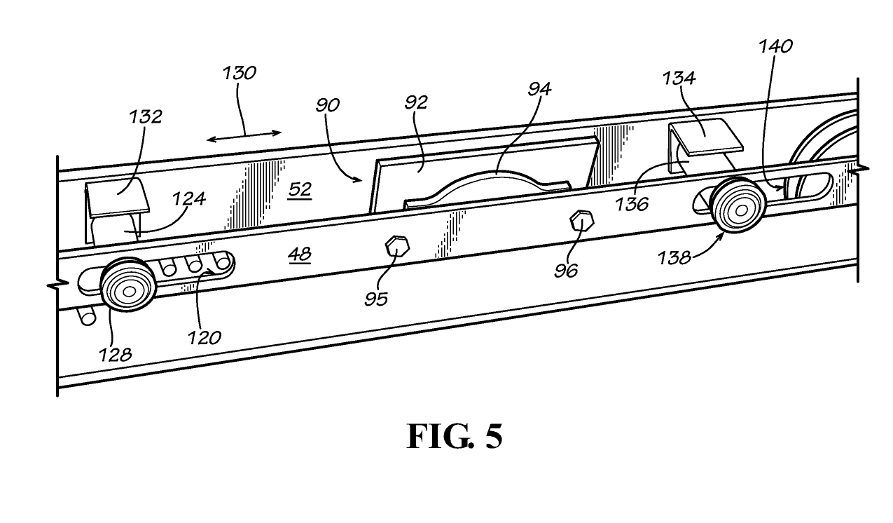

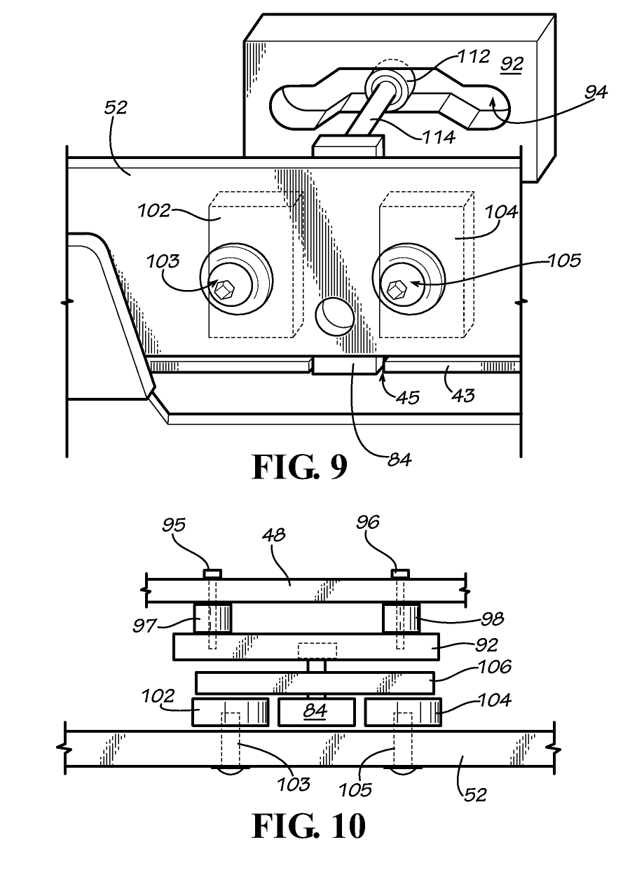

The upper lock 84 is operated by an additional cam mechanism as best seen in FIGS. 5, 8A-8C, 9 and 10. The upper lock cam mechanism as generally indicated at 90 includes a cam plate 92 and a cam track 94. The cam plate 92 is bolted to cam bar 48 via bolts 95, 96. Alternatively, the cam plate can be secured in place by welding. As best seen in FIG. 10, the cam plate 92 is based a short distance from the cam bar 48 by spacers 97, 98. As seen in FIGS. 2 and 3, the upper lock bar 84, when extended to its lowered position, extends into a slot or notch formed in the horizontal portion 43 of the support frame 42 for securing the movable carriage 46 in place. This is perhaps best seen in FIG. 9 wherein when in the lowered position a bottommost portion of the upper lock bar 84 extends into a slot 45 formed in horizontal portion 43 of support frame 42. In this way, the upper lock bar 84 can be used to selectively lock the movable carriage 46 to the support frame 42 to prevent further movement of the movable carriage in one direction or the other.

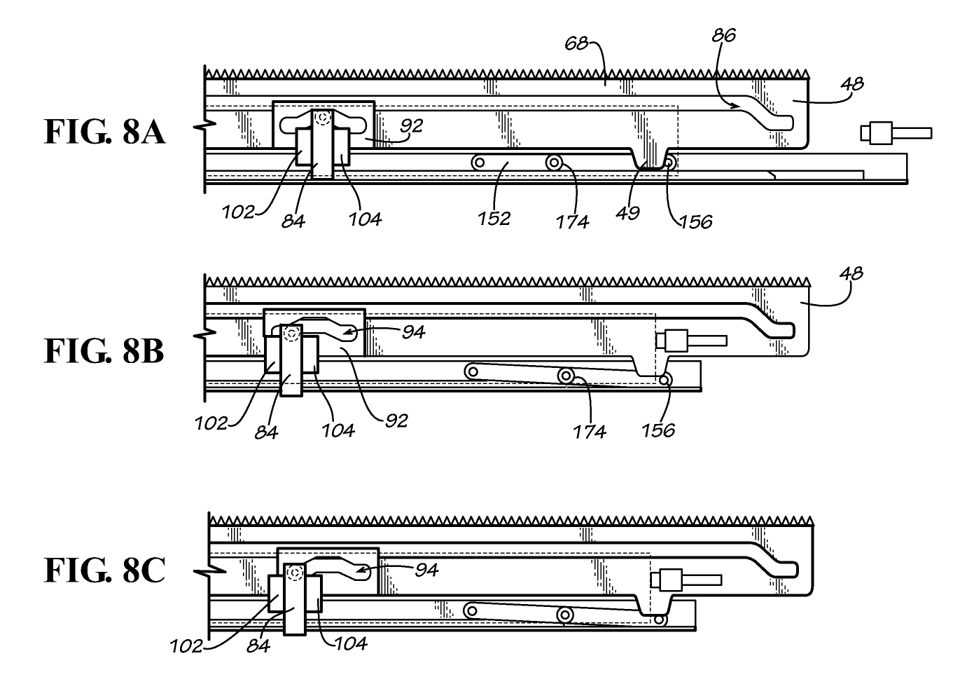

The upper lock bar 84 is guided between guide blocks 102, 104, as best seen in FIGS. 8A-8C, 9 and 10. Alternatively, the guide blocks can be secured in place by welding. The guide blocks 102, 104 are held in place and secured by bolts 103, 105 extending through the wheel bar 52. A guide plate or back or plate 106 is position behind the guide blocks 102, 104 and behind the upper lock bar 84. In this way, a channel is formed between the wheel bar 52, the guide plate 106, and the guide blocks 102, 104 in which the upper lock bar 84 is smoothly guided. The cam follower 112 rides within the cam track 94 of the cam plate 92 and is connected to the upper lock bar 84 by a cam pin or axle 114. This construction, as the cam plate 92 is moved back and forth laterally relative to the wheel bar 52, cam follower 112 rides within the track 94 to raise and lower the upper lock bar 84.

An advantageous feature of the construction of the upper lock bar and its related cam mechanism is that the upper lock bar is not visible or accessible to a prisoner, but instead is concealed within the cabinet, thereby making the door movement more resistant to vandalism and damage.

Advantageously, the provision of two locks (the upper lock 84 and the drop bar 80) makes it more difficult for the inmate(s) to dislodge the movement and door from the locked position, thereby increasing security of the door.

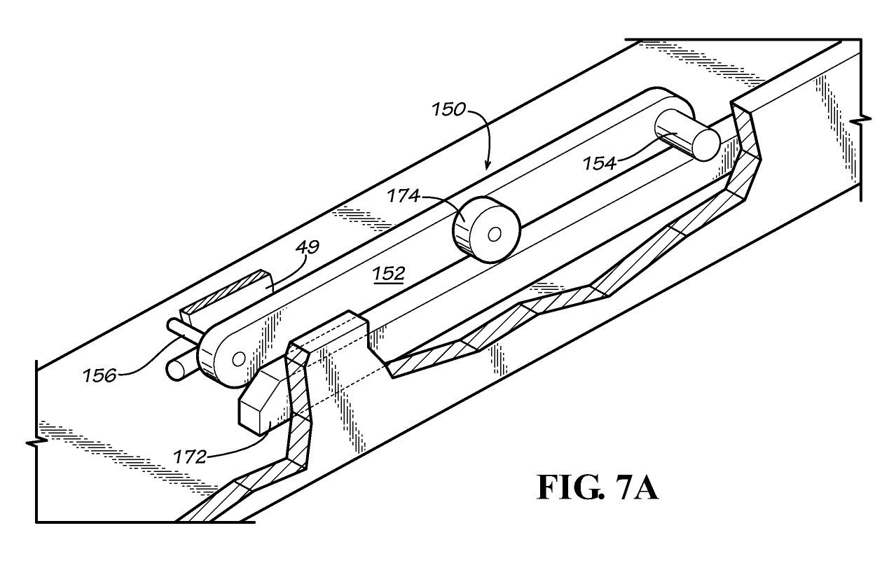

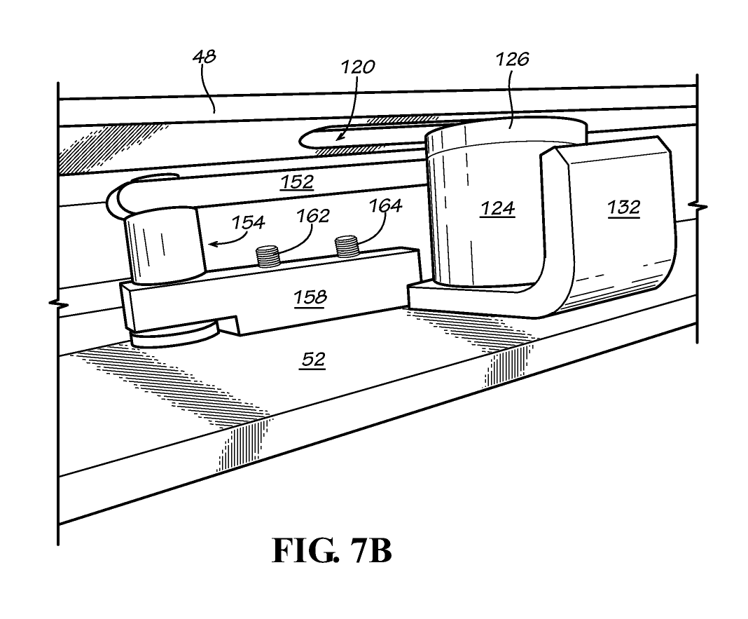

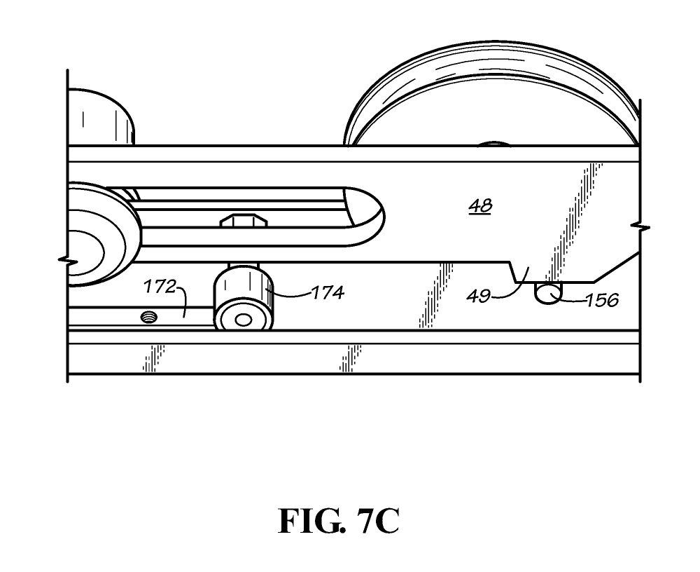

As best seen in FIGS. 6A-6C and 7B, 7C, the wheel bar 52 is mounted for sliding, back-and-forth movement relative to the cam bar 48. In this regard, the cam bar 48 is provided with elongated slots therein, such as slot 120. A large pin 124 is securely mounted to the wheel bar 52 and is slidingly connected to the cam bar 48 with bronze wear collars or bushings 126, 128. The bushings 126, 128 are each notched/flanged such that part of the bushings extends into the slot and another part of the bushing rides on the outside of the slot against the faces of the cam bar 48. In this way, the large pin 124 is closely guided to the slot 120 and the cam bar 48. In this way, the wheel bar 52 can move back and forth in the direction of the double-headed direction arrow 130 relative to the cam bar 48. Alternatively, instead of bronze bushings extending into the cam bar to act as a bearing for the cam bar, one can use bronze washers to constrain and guide the cam bar side-to-side, and have the wheel bar ride on bearings for relative movement vis-à-vis the cam bar, such as unground dual-row ball bearings.

Interposed between the large pin 124 and the wheel bar 52 is an L-shaped support bracket 132 for bracing supporting the underside of the rack 48. As shown in FIG. 5, another slot 140 is formed at another end of the cam bar 48 and a similar L-shaped support bracket 134 is interposed between large pin 136 and the wheel bar 52. Large pin 136 uses a similar flanged bushing arrangement, as generally indicated at 138. Large pins 124 and 136 are secured to the wheel bar 52 by bolts 142, 144, as best seen in FIG. 2.

The wheel bar 52 can be considered a sort of movable carriage for supporting and carrying the prison door therealong. The cam bar 48 is coupled to the wheel bar 52 via a timing mechanism comprising a timing link arm pivotally coupled to the movable carriage and selectively coupled to the cam bar. For example, FIG. 7A shows a schematic fashion a timing mechanism 150 or selectively coupling the wheel bar to the cam bar. The timing mechanism 150 includes a timing link 152. The timing link 152 is pivotally mounted by pivot axle 154 to the wheel bar 52. At an opposite end of the timing link 152, and extending from an opposite face thereof, a driven pin 156 is used to selectively couple and decouple the timing link 152 to the cam bar 48. In this regard, driven 156 selectively engages a toe or log portion 49 of the cam bar 48, I will become more clear in consideration of FIGS. 8A-8C. Turning now to FIG. 7B, one can see the attachment of the timing link 152 to the wheel bar 52 by way of pivot axle 154 and pivot axle 154 is mounted to a mounting bracket 158, which in turn is bolted to the wheel bar to my way of a pair of bolts and 62, 164. As seen in FIG. 2, these bolts 162:64 are toward the right and the wheel bar to. Thus, there is one such timing mechanism secured to the right end of the wheel bar 52. Similarly, a second timing mechanism secured to the other end of the wheel bar 52 with bolts 166, 168. The two-time mechanisms are identical in construction to one another, but are mirror images of one another.

As best seen in FIGS. 7A and 7C, the timing mechanism 150 includes a timing cam 172 and a timing link roller 174 mounted to the timing link 152 and following the timing cam 172. The timing link roller 174 rides along the timing cam 172 and at one or more selected locations allows the timing link arm to rotate out of engagement with the cam bar 48 to decouple the timing link 150 from the cam bar. In this way, the motion of the wheel bar 52 can be coupled and decouple from the motion of the cam bar 48. Indeed, for a portion of the motion of the cam bar 48 the cam bar and the wheel bar 52 move together, and for some other portion of the motion of the cam bar 48, the cam bar continues its motion while the wheel bar 52 remains stationary. Moreover, motion of the cam bar 48 while the movable carriage is stationary causes the locking and unlocking of the drop bar and the upper lock bar. In this regard, cam bar 48 and its cam mechanisms are designed such that during the cooperative movement in which both the cam bar in the wheel bar move together, neither the upper lock or the drop bar are engaged, but instead are retracted. Moreover, when these cam mechanisms are configured such that when the wheel bar's motion stops in the cam bars motion continues, cam followers enter into portions of the cam tracks which cause the cam followers to force the upper lock bar into its lock position and the drop bar into its locked position.

FIGS. 8A-8C show the operation of the timing mechanisms 150 in schematic fashion. Beginning in FIG. 8A, this figure shows the wheel bar and the cam bar coupled to one another for coordinated movement therealong. In this regard, foot or lug portion 49 engages the driven pin 156 and pushes the driven pin along. Thus, as the rack 68 is driven by the motor to move the cam bar 48 to the right as shown in this figure, the lug 49 pushes the driven pin 156 also to the right. This movement of the driven pin 156 to the right drags the timing link 152 therealong. The timing link 152, being coupled to the wheel bar, causes the wheel bar to also move to the right. As shown in FIG. 8D, at a certain point the timing roller 174 reaches the end of the timing cam 172 and drops slightly. This allows the far end of the timing link 152 to drop beneath the lug 49 of the cam bar 48. In this way, the driven pin 156 is moved to a point where it is no longer driven by the lug 49. Thus, from this point forward, the cam bar 48 can be driven further to the right, while the wheel bar remains stationary, as was depicted in FIG. 8C.

Advantageously, such a mechanism allows for the provision of a single motor for moving the wheel bar back and forth and for locking the drop bar and the upper lock bar in place, with the motor driving the wheel bar along until the movable wheel bar reaches a certain position at which the wheel bar stops, stopping further movement of the door, while the motor continues to drive the cam bar further, causing the cam bar to operate the drop bar and the upper lock bar. Thus, a single motor is used to both move the door and to operate the locking mechanisms.

It is to be understood that this invention is not limited to the specific devices, methods, conditions, or parameters of the example embodiments described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the claimed invention has been shown and described in example forms, it will be apparent to those skilled in the art that many modifications, additions, and deletions can be made therein without departing from the spirit and scope of the invention as defined by the following claims.

What is claimed is:

1. A transport and locking mechanism for mounting above a prison door adjacent a prison cell for transporting and locking the prison cell door, the transport and locking mechanism comprising:
a support frame;
a movable carriage mounted to the support frame for reciprocating motion relative to the support frame for transporting the prison cell door back and forth;
a drop bar extending downwardly toward a floor of the prison and being movable between a raised unlocked position and a lowered locked position in which a lower portion of the drop bar is secured adjacent the floor of the prison;
an upper lock movable between a first locked position securing the movable carriage in place and a second unlocked position allowing motion of the movable carriage;
one or more cam mechanisms for positively moving the upper lock between its locked and unlocked positions; and
wherein the one or more cam mechanisms are operated by reciprocating motion of the movable carriage such that the reciprocating motion of the movable carriage causes the locking and unlocking of the upper lock.

2. A transport and locking mechanism as claimed in claim 1 wherein the upper lock comprises a cam-operated upper lock bar guided for movement into and out of engagement with a notch formed in the movable carriage to selectively lock the movable carriage in place despite attempts at vandalism and thereby to prevent forces created by such attempts at vandalism from being transmitted to the other parts of the transport and locking mechanism.

3. A transport and locking mechanism as claimed in claim 1 wherein the upper lock is operable for securing the movable carriage directly to the support frame.

4. A transport and locking mechanism as claimed in claim 1 wherein the support frame, the movable carriage and the upper lock bar are concealed within a cabinet to prevent access to the same by prisoners.

5. A transport and locking mechanism as claimed in claim 1 wherein the one or more cam mechanisms comprises a cam bar which is coupled to the movable carriage in such a way that for a portion of the motion of the cam bar, the cam bar and the movable carriage move together, and for some other portion of the motion of the cam bar, the cam bar continues its motion while the movable carriage remains stationary and wherein motion of the cam bar while the movable carriage is stationary causes the locking and unlocking of the drop bar and the upper lock.

6. A transport and locking mechanism as claimed in claim 5 wherein the cam bar is coupled to the movable carriage via a timing mechanism comprising a timing link arm pivotally coupled to the movable carriage and selectively coupled to the cam bar.

7. A transport and locking mechanism as claimed in claim 6 wherein the timing mechanism includes a timing cam and a timing link roller mounted to the timing link arm and following the timing cam, wherein the timing link roller rides along the timing cam and at one or more selected locations allows the timing link arm to rotate out of engagement with the cam bar to decouple the timing link arm from the cam bar.

8. A transport and locking mechanism as claimed in claim 5 wherein the cam bar is coupled to the movable carriage in such a way that for a portion of the motion of the cam bar the cam bar and the movable carriage move together, and for some other portion of the motion of the cam bar, the cam bar continues its motion while the movable carriage remains stationary, and wherein motion of the cam bar while the movable carriage is stationary causes the locking and unlocking of the drop bar and the upper lock.

9. A transport and locking mechanism as claimed in claim 8 wherein a single motor is provided for moving the movable carriage back and forth and for locking the drop bar and the upper lock in place, with the motor driving the movable carriage along until the movable carriage reaches a certain position at which the movable carriage stops, stopping further movement of the door, while the motor continues to drive the cam bar further, causing the cam bar to operate the drop bar and the upper lock.

10. A transport and locking mechanism as claimed in claim 1 further comprising a door hanging bracket affixed to the movable carriage for supporting the door below the movable carriage and for moving the door back and forth along with the movable carriage.

11. A transport and locking mechanism for mounting in a cabinet above a prison door adjacent a prison cell for transporting and locking the prison door, the transport and locking mechanism comprising:
a support frame adapted to be mounted within the cabinet;
a movable carriage mounted to the support frame for reciprocating motion relative to the support frame;
a drop bar extending downwardly toward the floor of the prison and being movable between a raised unlocked position and a lowered lock position in which a lower portion of the drop bar is secured adjacent the floor of the prison; and
an upper lock including an upper lock bar movable between a first locked position securing the movable carriage to the support frame and a second unlocked position allowing relative motion between the movable carriage and the support frame, the upper lock not being visible or accessible to a prisoner, but instead being concealed within the cabinet.

12. A transport and locking mechanism as claimed in claim 11 further comprising a cam bar which is coupled to the movable carriage in such a way that for a portion of the motion of the cam bar, the cam bar and the movable carriage move together, and for some other portion of the motion of the cam bar, the cam bar continues its motion while the movable carriage remains stationary.

13. A transport and locking mechanism as claimed in claim 12 and wherein motion of the cam bar while the movable carriage is stationary causes the locking and unlocking of the drop bar and the upper lock.

14. A transport and locking mechanism as claimed in claim 12 wherein the cam bar is selectively coupled to the movable carriage via a timing mechanism comprising a timing link arm pivotally coupled to the movable carriage and selectively coupled to the cam bar.

15. A transport and locking mechanism as claimed in claim 14 wherein the timing mechanism includes a timing cam and a timing link roller mounted to the timing link arm and following the timing cam, wherein the timing link roller rides along the timing cam and at one or more selected locations allows the timing link arm to rotate out of engagement with the cam bar to decouple the timing link arm from the cam bar.

16. A transport and locking mechanism as claimed in claim 12 wherein the cam bar is coupled to the movable carriage in such a way that for a portion of the motion of the cam bar the cam bar and the movable carriage move together, and for some other portion of the motion of the cam bar, the cam bar continues its motion while the movable carriage remains stationary, and wherein motion of the cam bar while the movable carriage is stationary causes the locking and unlocking of the drop bar and the upper lock.

17. A transport and locking mechanism as claimed in claim 16 wherein a single motor is provided for moving the movable carriage back and forth and for locking the drop bar and the upper lock bar in place, with the motor driving the movable carriage along until the movable carriage reaches a certain position at which the movable carriage stops, stopping further movement of the door, while the motor continues to drive the cam bar further, causing the cam bar to operate the drop bar and the upper lock.

18. A transport and locking mechanism for mounting in a cabinet above a prison door adjacent a prison cell for transporting and locking the prison door, the transport and locking mechanism comprising:
a support frame;
a movable carriage mounted to the support frame for reciprocating motion relative to the support frame and for bearing the door therealong;
one or more locks movable between locked and unlocked positions for securing the door in place;
a cam bar mounted for reciprocating motion relative to the support frame for moving the one or more locks between their locked and unlocked positions;
wherein the cam bar is coupled to the movable carriage in such a way that for a portion of the motion of the cam bar the cam bar and the movable carriage move together, and for some other portion of the motion of the cam bar, the cam bar continues its motion while the movable carriage remains stationary, and wherein motion of the cam bar while the movable carriage is stationary causes the locking and unlocking of the one or more locks; and
wherein the cam bar is coupled to the movable carriage via a timing mechanism comprising a timing link arm pivotally coupled to the movable carriage and selectively coupled to the cam bar and
wherein the timing mechanism includes a timing cam and a timing link roller mounted to the timing link arm and following the timing cam, wherein the timing link roller rides along the timing cam and at one or more selected locations allows the timing link arm to rotate out of engagement with the cam bar to decouple the timing link arm from the cam bar.

19. A transport and locking mechanism as claimed in claim 18 wherein the cam bar is coupled to the movable carriage in such a way that for a portion of the motion of the cam bar the cam bar and the movable carriage move together, and for some other portion of the motion of the cam bar, the cam bar continues its motion while the movable carriage remains stationary, and wherein motion of the cam bar while the movable carriage is stationary causes the locking and unlocking of the drop bar and the upper lock bar.

20. A transport and locking mechanism as claimed in claim 19 wherein a single motor is provided for moving the movable carriage back and forth and for locking the drop bar and the upper lock bar in place, with the motor driving the movable carriage along until the movable carriage reaches a certain position at which the movable carriage stops, stopping further movement of the door, while the motor continues to drive the cam bar further, causing the cam bar to operate the drop bar and the upper lock bar.

21. A transport and locking mechanism as claimed in claim 18 further comprising a door hanging bracket affixed to the movable carriage for supporting the door below the movable carriage and for moving the door back and forth along with the movable carriage.
